(19) United States
(12) Patent Application Publication
(10) Pub. No.: US 2010/0058319 A1
(43) Pub. Date: Mar. 4, 2010

(54) AGILE DEPLOYMENT OF SERVER

(75) Inventors: Tomohiro Kawaguchi, Cupertino, CA (US); Yasunori Kaneda, San Jose, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/200,844

(22) Filed: Aug. 28, 2008

(51) Int. Cl. G06F 9/445

(52) U.S. Cl. 717/172

(57) ABSTRACT

System and method for agile deployment of servers. The system includes one or more storage subsystems, a host computer and a storage management server or general severs together with a system management server. A system administrator or a storage supplier preliminarily installs an application package on a server. The application package may include an operating system, programs, libraries, configuration data and initial data. When the system requires a new physical or virtual server, the system administrator replicates the installed application package and conducts the new server runs with the replicated application package. Operation sequences are provided for order of copying of the application package between the management servers and the storage subsystems. Change in the data from an initial state may be stored instead of the complete data.

### FIELD OF THE INVENTION

This invention relates in general to methods and systems for providing agility in installation and establishment of information technology (IT) systems and, more particularly, to providing agility in replicating software packages that are necessary for operation of servers.

### DESCRIPTION OF THE RELATED ART

In many cases, an IT administrator needs to set up multiple instances of physical or virtual servers in order to establish an IT system. During this process, the IT administrator needs to first install the operating system, the programs, libraries, configuration data and initial data for each server instance and then set up the physical or virtual servers themselves. This process is generally quite labor intensive and time consuming.

Therefore, there is a need for systems and methods that can replicate and install operating systems, application packages and other programs and data between servers with agility.

### SUMMARY OF THE INVENTION

The inventive methodology is directed to methods and systems that substantially obviate one or more of the above and other problems associated with conventional techniques for deploying multiple server instances.

In one aspect of the present invention a system administrator or a storage supplier preliminarily installs an application package in a storage system. The aforesaid application package may include an operating system, programs, libraries, configuration data and initial data. When the system requires a new physical or virtual server, the system administrator replicates the installed application package and configures the new server for execution with the replicated application package.

In accordance with one aspect of the inventive concept, there is provided a computer-implemented method performed in a system incorporating a storage system having multiple logical volumes, a host computer and a storage management server. The inventive method involves: installing at least one software package on a source logical volume of the multiple logical volumes; recording a purpose of the source logical volume having the software package installed thereon; receiving a volume selection from a user identifying the target volume of the multiple logical volumes; receiving a target volume purpose selection from the user; and using the target volume purpose selection to locate a source volume corresponding to the target volume purpose selection. The inventive method further involves using the source volume to replicate the at least one software package to the target volume; and configuring the host computer or the storage management server to operate with the target volume.

In accordance with another aspect of the inventive concept, there is provided a computer-implemented method performed in a system. The system includes a storage system including multiple logical volumes, a host computer and a storage management server. The inventive method involves: installing at least one software package on a source logical volume of the multiple logical volumes; recording a purpose of the source logical volume having the software package installed thereon; receiving a volume selection from a user identifying the target volume of the logical volumes; and receiving a target volume purpose selection from the user; using the target volume purpose selection to locate a source volume corresponding to the target volume purpose selection. The inventive method further involves using the source volume to perform a snapshot copy of the at least one software package to the target volume; and configuring the host computer or the storage management server to operate with the target volume. The target volume is a virtual volume having no physical storage capacity.

In accordance with yet another aspect of the inventive concept, there is provided a computer-implemented method performed in a system. The system includes a storage system having multiple logical volumes and a physical server platform. The inventive method involves installing at least one software package on a source logical volume of the multiple logical volumes; recording a purpose of the source logical volume having the software package installed thereon; establishing at least one new virtual server on a physical server platform; receiving a volume selection from a user identifying the target volume of the multiple logical volumes; receiving a target volume purpose selection from the user; and using the target volume purpose selection to locate a source volume corresponding to the target volume purpose selection. The inventive method further involves using the source volume to replicate the at least one software package to the target volume; and configuring the at least one new virtual server to operate with the target volume.

In accordance with a further aspect of the inventive concept, there is provided a computer-implemented method performed in a system. The system including: at least a first and a second storage subsystems each having multiple logical volumes and a physical server platform. The inventive method involves installing at least one software package on a source logical volume of the multiple logical volumes of the first storage subsystem; recording a purpose of the source logical volume having the software package installed thereon; establishing at least one new-virtual server on the physical server platform; receiving a volume selection from a user identifying the target volume of the logical volumes of the second storage subsystem; receiving a target volume purpose selection from the user; and using the target volume purpose selection to locate a source volume corresponding to the target volume purpose selection. The inventive method further involves using the source volume to replicate the at least one software package to the target volume; and configuring the at least one new virtual server to operate with the target volume.

In accordance with yet further aspect of the inventive concept, there is provided a computerized system including: a host computer; a storage management server; a storage subsystem including multiple logical volumes and a storage management terminal, the logical volumes including a source logical volume storing at least one software package; the storage management terminal operable to record a purpose of the source logical volume having the software package installed thereon; receive a volume selection from a user identifying the target volume of the multiple logical volumes; receive a target volume purpose selection from the user; use the target volume purpose selection to locate a source volume corresponding to the target volume purpose selection; and use the source volume to cause the at least one software package to be replicated to the target volume; a host computer, wherein the host computer or the storage management server is operable to be configured to operate with the target volume; and a storage network coupling the storage subsystem, the storage management server and the host computer.

In accordance with yet further aspect of the inventive concept, there is provided a computerized system including a host computer; a storage management server; a storage subsystem including multiple logical volumes and a storage management terminal, the logical volumes including a source logical volume storing at least one software package; the storage management terminal operable to record a purpose of the source logical volume having the software package installed thereon; receive a volume selection from a user identifying the target volume of the multiple logical volumes; receive a target volume purpose selection from the user; use the target volume purpose selection to locate a source volume corresponding to the target volume purpose selection; and use the source volume to cause the at least one software package to be snapshot copied to the target volume; a host computer, wherein the host computer or the storage management server is operable to be configured to operate with the target volume; and a storage network coupling the storage subsystem, the storage management server and the host computer. In the above system the target volume is a virtual volume having no physical storage capacity.

In accordance with still further aspect of the inventive concept, there is provided a computerized system including: at least one physical server platform operable to host at least one virtual server; at least one storage subsystem including multiple logical volumes, the logical volumes including a source logical volume storing at least one software package; a system management server operable to record a purpose of the source logical volume having the software package installed thereon; receive a volume selection from a user identifying the target volume of the multiple logical volumes; receive a target volume purpose selection from the user; deploy a new virtual server using the physical server platform; use the target volume purpose selection to locate a source volume corresponding to the target volume purpose selection; and use the source volume to cause the at least one software package to be replicated to the target volume; and a storage network coupling the storage subsystem, the system management server and the physical server platform. In the above system, the new virtual server is configurable to operate with the target volume.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows a physical and logical system configuration according to a first aspect of the present invention.

FIG. 2 shows an exemplary logical volume management table, according to the aspects of the invention.

FIG. 3 shows an exemplary packet management table, according to aspects of the present invention.

FIG. 4 shows an exemplary deployment interface, according to aspects of the present invention.

FIG. 5 shows an exemplary provisioning operation sequence of the storage management server being part of a system according to the first aspect of the present invention.

FIG. 6 shows an exemplary the provisioning operation sequence of a host computer being part of a system according to the first aspect of the present invention.

FIG. 7 shows a physical and logical system configuration according to a second aspect of the present invention.

FIG. 8 shows a logical volume management table according to aspects of the present invention.

FIG. 9 shows a physical and logical system configuration according to a third aspect of the present invention.

FIG. 10 shows an exemplary deployment table, according to aspects of the invention.

FIG. 11 shows an exemplary deployment interface, according to aspects of the present invention.

FIG. 12 shows an exemplary provisioning operation sequence of a virtual server, according to the third aspect of the present invention.

FIG. 13 shows a physical and logical system configuration according to a fourth aspect of the present invention.

FIG. 14 shows an exemplary logical volume management table according to aspects of the present invention.

FIG. 15 shows an exemplary provisioning operation sequence of a virtual server in a system according to the fourth aspect of the present invention.

FIG. 16 shows a physical and logical system configuration according to a fifth aspect of the present invention.

FIG. 17 shows an exemplary deployment table according to aspects of the present invention.

FIG. 18 shows an exemplary provisioning operation sequence of a virtual server in a system according to the fifth aspect of the present invention.

FIG. 19 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Aspects of the present invention provide systems and methods for replicating operating system, programs, libraries, configuration data, initial data and application packages between actual and virtual servers. Various inventive aspects of the present invention are presented as divided between first, second, third, fourth and fifth embodiments. The divisions are for ease of description and features presented under one aspect of the invention may be combined with features presented under other aspects.

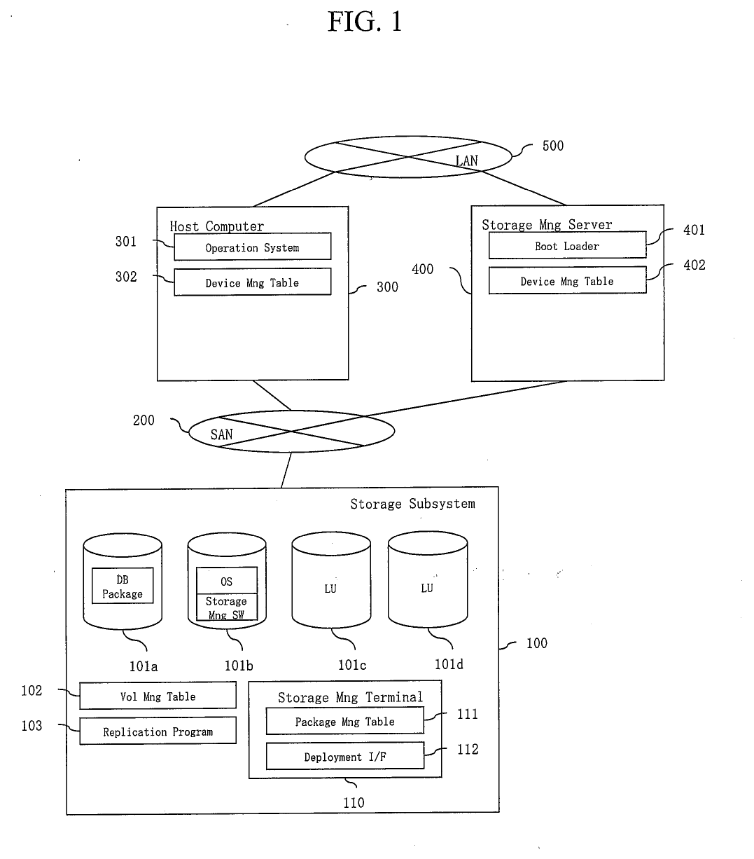

FIG. 1 shows a physical and logical system configuration according to a first aspect of the present invention.

The physical system configuration includes a storage subsystem 100, a host computer 300 and a storage management server 400 that are coupled together through a storage area network (SAN) 200. The host computer 300 and the storage management server 400 are further coupled together through a server network 500 that may be implemented as a local area network (LAN).

The storage subsystem 100 provides storage volumes for storing programs and data. The host computer 300 hosts some applications that execute on the host computer. The storage management server 400 manages the storage subsystem 100 and logical units 101 that are located on the storage subsystem 100. The server network 500 links the servers together. The storage network 200 links the host, the server and the storage subsystem.

The storage subsystem 100 includes logical units or volumes 101a, 101b, 101c, 101d that provide storage capacity for servers connected to the storage subsystem. Volume 101a includes the installed application programs, libraries and data to operate applications on host computer 300. Volume 101a is shown as including database (DB) packages. Volume 101b includes the installed operating systems and storage management software to conduct storage management on the storage management server 400. Volumes 101c and 101d are shown as being empty.

The storage subsystem 100 also includes a logical volume management table 102 for storing management information for the volumes 101a, 101b, 101c, 101d. The volume management table 102 includes mapping information between theological volumes of the storage subsystem 100 and logical devices numbers. The logical device numbers are internal information of the storage subsystem 100.

The storage subsystem 100 also includes a replication program 103 that causes the volumes to replicate.

The storage subsystem 100 also includes a storage management terminal 110 that provides an interface for using the storage subsystem 100. The storage management terminal 110 includes a package management table 111 that manages the volumes and the installed software and a deployment interface 112 that provides a human interface for an IT administrator for volume deployment.

The host computer 300 includes an operation system 301 that controls application programs and devices and a device management table 302 that stores device information that the host computer 300 uses.

The storage management server 400 includes a boot loader 401 that loads and runs the operating system when the server starts or restarts. The storage management server 400 also includes a device management table 402 that stores device information that the host computer 300 uses.

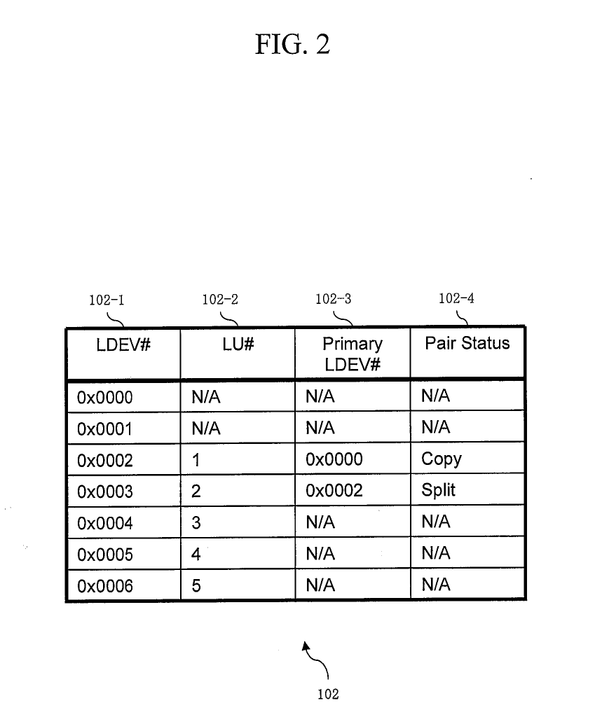

FIG. 2 shows an exemplary logical volume management table, according to the aspects of the invention.

The logical volume management table 102 includes four columns corresponding to a logical volume number (LDEV #) 102-1, a logical unit number (LU #) 102-2, a primary logical volume number (Primary LDEV #) 102-3, and a pair status (Pair Status) 102-4. The logical volume number 102-1 is a unique volume number in the storage subsystem 100 for managing internal device structures. The logical unit number 102-2 is a volume number to be provided to servers. An entry of “N/A” in this column means that the logical volume doesn't provide storage space to servers. The primary logical volume number 102-3 stores source logical volume number of the source volume that is replicated into the corresponding logical unit number. An entry of “N/A” in column 102-3 means that no source volume was replicated into the corresponding logical unit 102-2 or the corresponding logical volume 102-1.

The pair status column 102-4 stores the pair status of the volume shown in 102-1. “Copy” means the volume is copying, meaning it is involved in the process of copying, and cannot be accessed. “Split” means that the volume has not completed copying but can be accessed because an initialization operation has finished and the copying process runs in background. “N/A” means that the volume in 102-1 has neither been replicated from a source nor is it a source to be replicated to another volume. Therefore, “N/A” would indicate that the volume has not been replicating and is accessible. The state transition occurs from “N/A” to “Copy” to “Split.” If a copy request is received when the state is “N/A” then the state transitions to “Copy” where initialization is completed and then to “Split” when copying is being run in the background but initialization is complete and the volume is accessible.

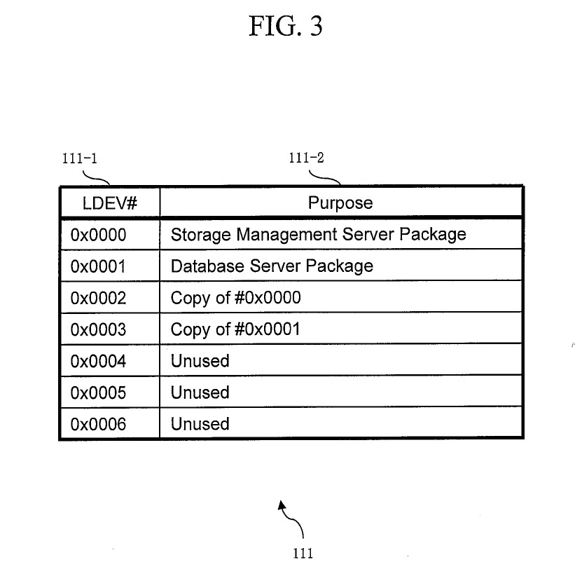

FIG. 3 shows an exemplary packet management table, according to aspects of the present invention.

The package management table 111 includes two columns including the logical volume number (LDEV#) 111-1 and a purpose (Purpose) 111-2. The logical volume number 111-1 is the unique volume number in the storage subsystem 100 for managing internal device structure. The purpose 111-2 stores purpose of this volume.

For example, a replicated volume is stored as “Copy of . . . ,” and an entry of “Unused” means that the volume does not exist. “Unused” may also mean that the volume was neither replicated nor configured as a source volume.

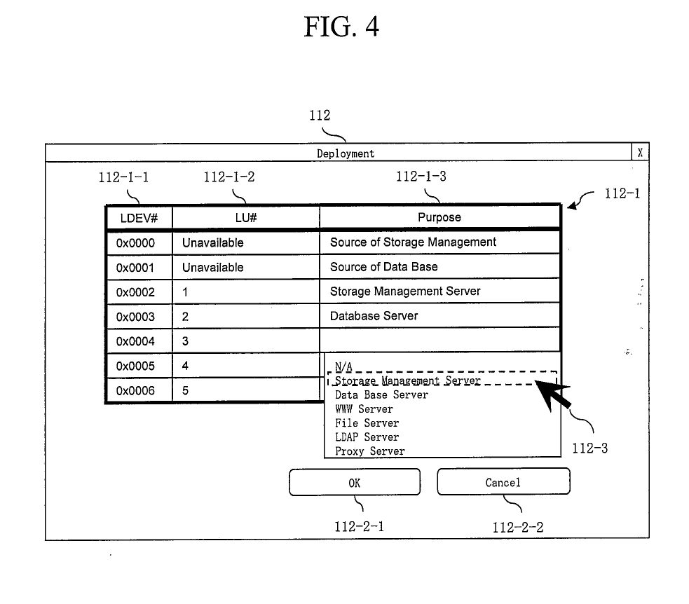

FIG. 4 shows an exemplary deployment interface, according to aspects of the present invention.

The deployment interface 112 provides the human interface for an IT administrator and includes a volume configuration interface 112-1 that is in the shape of a table. Entries in this table can be both selected by a pointer 112-3 and input by keyboard. The storage management terminal 110 reads the logical volume management table 102 and the package management table 111 and generates a logical volume number 112-1-1, a logical unit number 112-1-2 and a purpose of volume 112-1-3 as entries for the volume configuration table 112-1. The logical volume number 112-1-1 is the unique volume number in the storage subsystem 100 for managing the internal device structure. The logical unit number 112-1-2 corresponds to the logical unit number 102-2 in the logical volume management table 102 of FIG. 2 and is a volume number to be provided to the servers. An entry of “Unavailable” in the column 112-1-2 means that the logical volume does not have a defined LU #. The purpose column 112-1-3 stores the purpose of the volume as, for example, a source of storage management information. In the purpose column, the purpose of the source volumes is stored as “Source of . . . . ”

An OK button 112-2-1 and a cancel button 112-2-2 are also shown. When the OK button 112-2-1 is pushed, the storage, management terminal 110 stores the status of the package management table 111, tells the storage subsystem 100 to change the logical volume management table 102 and activates the replication program 103 to replicate. The storage management terminal 110 activates the replication program 103, only if at least one of the purposes of the source volumes in the purpose column 112-1-3 has been changed. If the source volumes retain their original purpose, replication is not repeated. When the cancel button 112-2-2 is pushed, the storage management terminal 110 destroys the changes to the volume configuration table 112-1. The pointer 112-3 works with mouse operation.

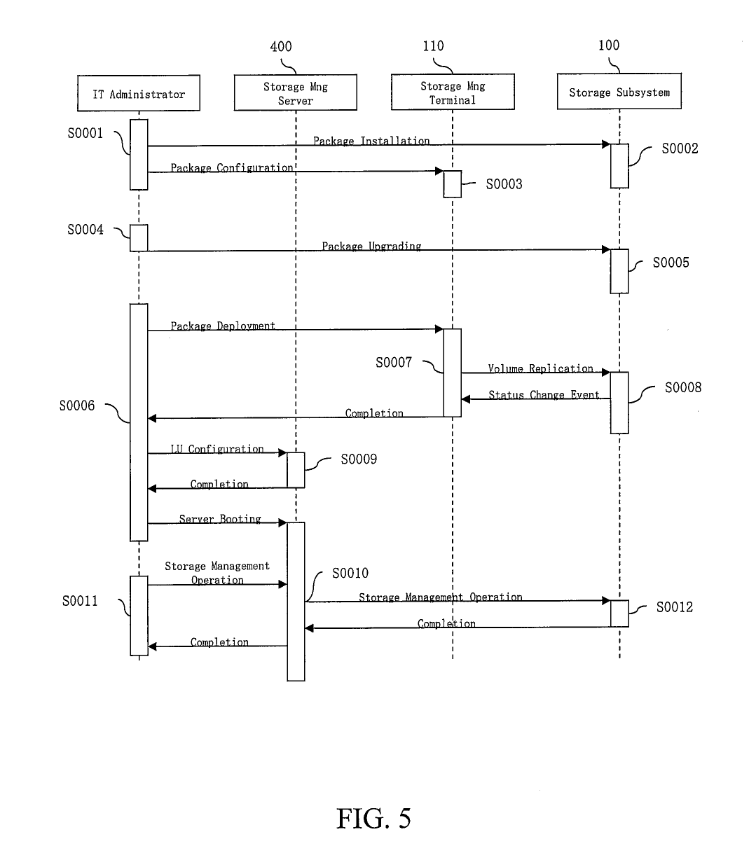

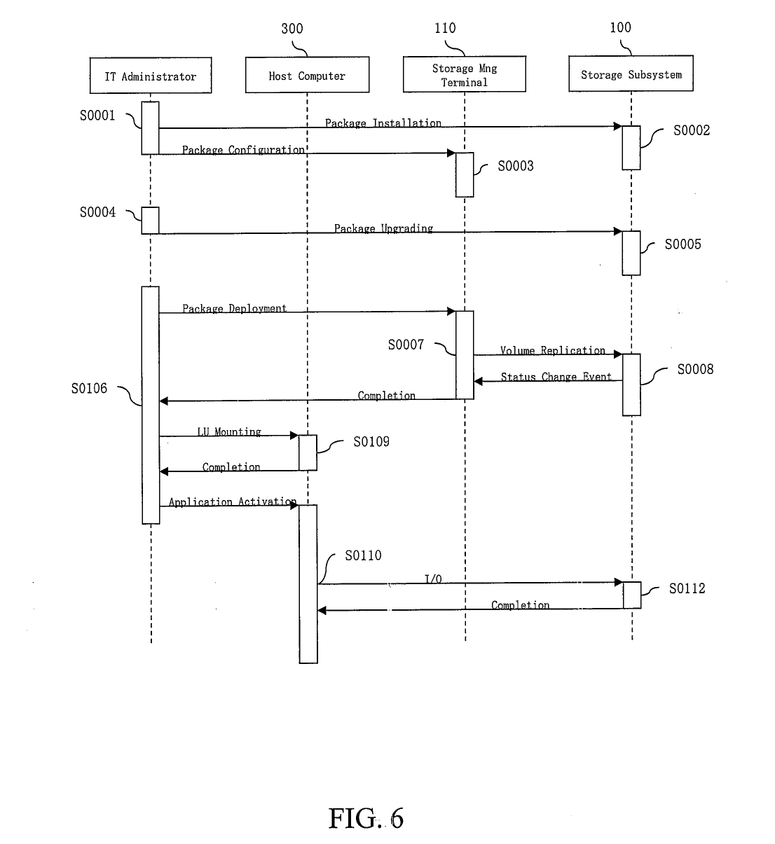

FIG. 5 and FIG. 6 each show an exemplary operation sequence of an embodiment of the inventive system.

FIG. 5 shows an exemplary provisioning operation sequence of the storage management server being part of a system according to the first aspect of the present invention.

The sequence of the provisioning operation at the storage management server 400 includes processes S0001 through S0012 that are executed as described below.

At S0001, the IT administrator installs the operating system and the storage management software on the volume 101b. As a result of this operation, S0002 runs. After the installation operation, the IT administrator sets the volume purpose to purpose of volume 112-1-3 found in table 112-1 of FIG. 4. As a result-of this operation, S0003 runs.

At S0002, the storage subsystem 100 stores the operating system and the storage management software on volume 101b.

At S0003, the storage management terminal 110 changes the purpose of volume 111-2 column in the package management table 111 for the volume 101b.

At S0004, if there is an update for the installed operating system or storage management software, the IT administrator conducts the updates. This process allows downloading the updates from the internet. As a result of this operation, S0005 runs.

At S0005, the storage subsystem 100 stores updates of the operating system or the storage management software on the volume 101b.

At S0006, the IT Administrator selects a volume and sets a purpose for it on the storage management terminal 110 and waits for the completion return. As a result of this operation, S0007 runs. The IT administrator further sets the storage management server 400 to recognize the foresaid volume to boot and waits for the completion return. As a result of this operation, S0009 runs. The IT administrator further causes the storage management server 400 to boot.

At S0007, the storage management terminal 110 finds the source volume by analyzing the set purpose. The storage management terminal 110 orders the storage subsystem 100 to replicate the aforesaid source volume to the designated volume and waits to change the volume status to “Split” which indicates an accessible volume and after this operation completes, the storage management terminal 110 returns a complete message. As a result of this operation, S0008 runs.

At S0008, the storage subsystem 100 changes the status of target volume to “Copy” which indicates an inaccessible volume and starts the replication operation. After-the initial part of the replication operation completes, the storage subsystem 100 changes the status to “Split.” By methods known in the art, the volume can become accessible soon after initialization. After the status changes to “Split,” the storage subsystem 100 returns the status change event message. In the “Split” status the storage subsystem 100 continues the copy process in the background.

At S0009, the storage management server 400 recognizes the designated volume as a boot volume. The storage management server 400 returns a completion message.

At S0010, the storage management server 400 boots and waits for a user operation. When a user operation occurs for a volume, the storage management server 400 forwards to the operation to the storage subsystem 100 and waits for the completion of the operation. After the operation completes, the storage management server 400 returns a completion message and waits for a user operation again.

At S0011, the IT administrator uses the storage management server 400 to configure the storage subsystem 100 and waits for the completion, i.e., for establishment of Snapshot, Backup and/or Disaster Recovery. As a result of this operation, S0010 is interrupted.

At S0012, the storage subsystem 100 sets configuration of the designated volume(s) and runs the designated operation. After the change in configuration and the operation are complete, the storage subsystem 100 returns a completion message.

FIG. 6 shows an exemplary the provisioning operation sequence of a host computer being part of a system according to the first aspect of the present invention.

The provisioning operation sequence of the host computer 300 uses volume 101a instead of the volume 101b that was used in FIG. 5.

This sequence includes S0001, S0002, S0003, S0004, S0005, S007 and S0008 that are similar to the processes described with respect to FIG. 5. This sequence, however, further includes processes S0106, S0109, S0110 and S0112 that are different.

At S0106, the IT administrator selects a volume and sets a purpose for it on the storage management terminal 110. By this operation, S0007 runs. The IT administrator waits for the completion return from the storage management terminal 110. The IT administrator also sets the host computer 300 to recognize the aforesaid volume to use and waits for the completion return from the host computer 300. By this operation, S0109 runs.

At S0109, the host computer 300 recognizes the designated volume. The host computer 300 returns a completion message.

At S0110, the host computer 300 runs the applications stored in the new volume and accesses the volume on the storage subsystem 100. By this operation, S0112 runs.

At S0112, the storage subsystem 100 receives read and write I/O commands and transfers the data to the host computer 300.

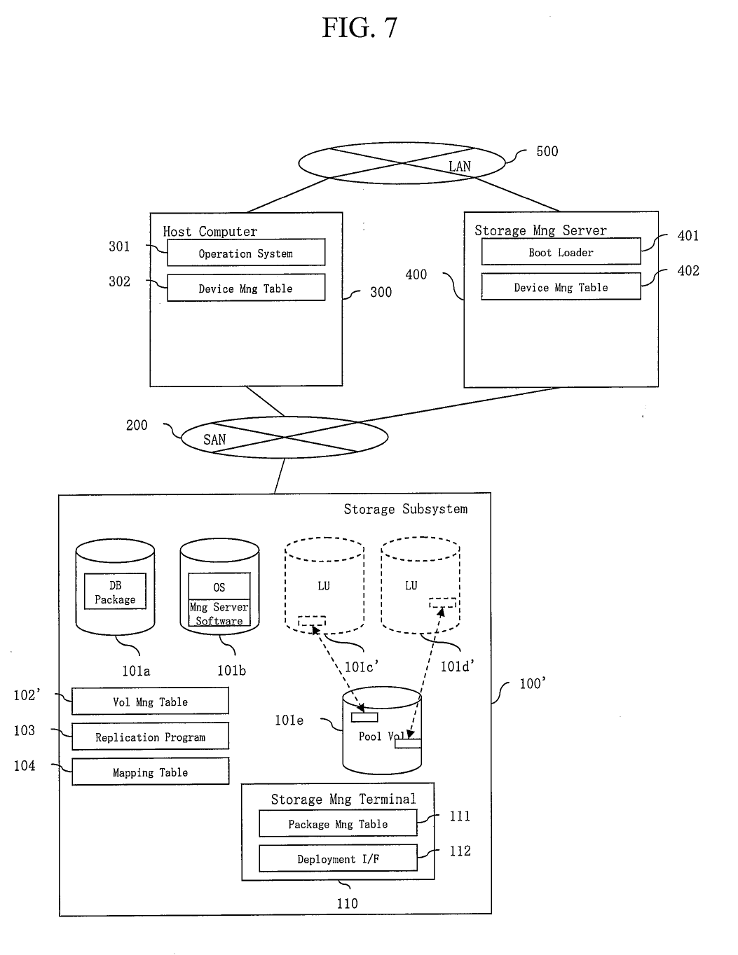

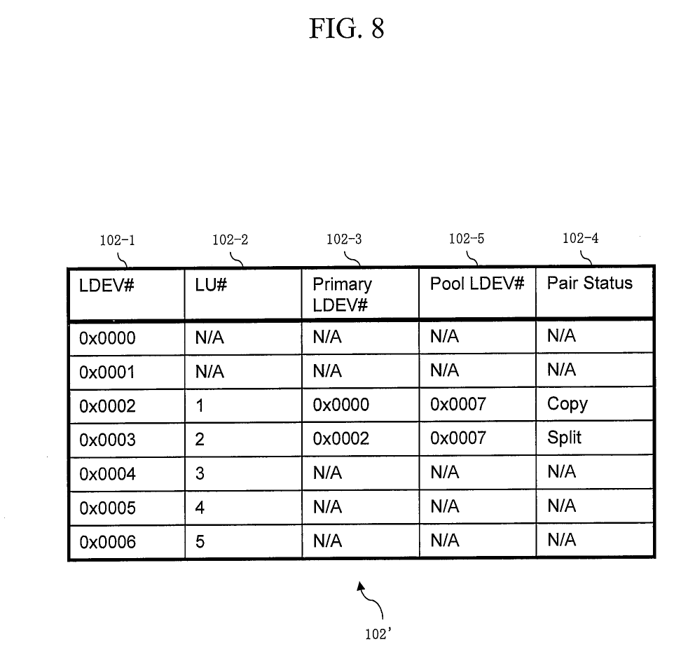

FIG. 7 and FIG. 8 pertain to features of a second aspect of the present invention. These drawings are used to show only the differences of the second aspect from the first aspect. The second aspect uses delta snapshot instead of full replication.

FIG. 7 shows a physical and logical system configuration according to a second aspect of the present invention.

The storage subsystem 100′ includes volumes 101a, 101b, 101c′, 101d′, 101e. Volumes 101c and 101d of the FIG. 1 are replaced by volumes 101c′ and 101d′ in FIG. 7 and a volume 101e is added in FIG. 7. The storage subsystem 100′ also includes a mapping table 104 that was not present in FIG. 1 and a different logical volume management table 102′.

The volumes 101c′ and 101d′ are virtual volumes that have no physical capacity and, as such, they are shown with dotted borders. When volumes 101c′ and 101d′ establish a pair with volumes 101a or 101b, the volumes 101c′ and 101d′ store the delta data of volumes 101a and 101b into the volume 101e and change the mapping table 104 to refer to the location of this delta data. Delta data is the difference between the data currently stored in 101a and 101b and the same data at a later point in time.

The volume 101e is an empty volume that can store the delta data of volume 101a and volume 101b.

The mapping table 104 refers the delta data of volume 101a and 101b between current time and some other point in time.

The logical volume management table 102′ has new parameters when compared with the logical volume management table 102 shown in FIG. 1 and FIG. 2.

FIG. 8 shows a logical volume management table according to aspects of the present invention.

The logical volume management table 102′ includes columns corresponding to a logical volume number (LDEV #) 102-1, a logical unit number (LU #) 102-2, a primary logical volume number (Primary LDEV #) 102-3, and a pair status (Pair Status) 102-4, and a pool volume number (Pool LDEV #) 102-5. The logical volume management table 102′ includes an extra column for the pool volume number 102-5 that was not present in the table 102 of FIG. 2. The column corresponding to the pool volume number 102-5 stores the number of the target volume that is used for storing the delta data.

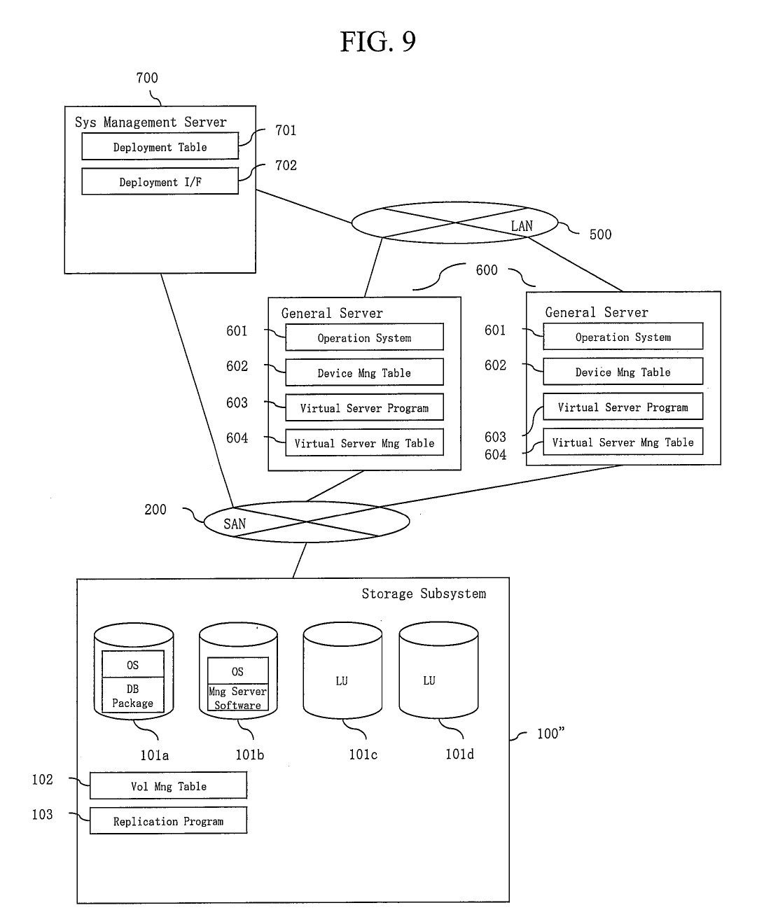

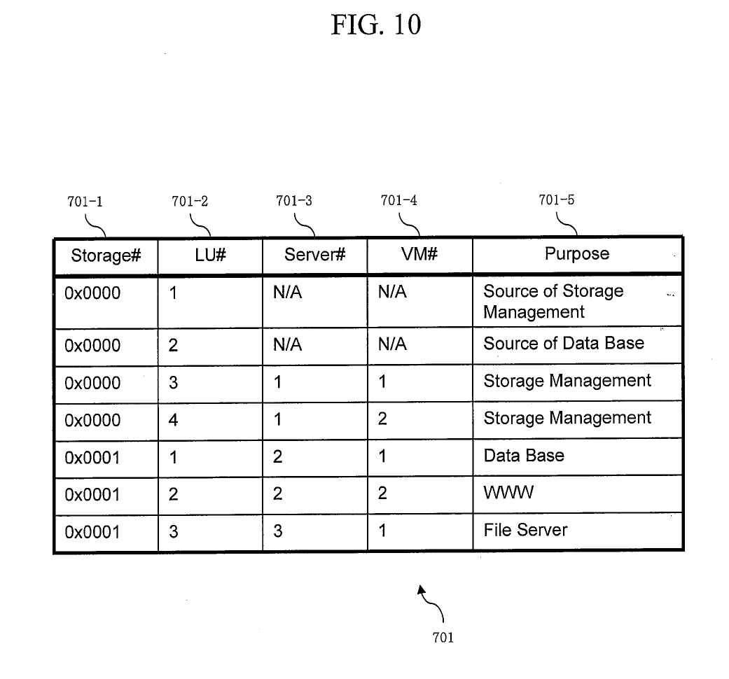

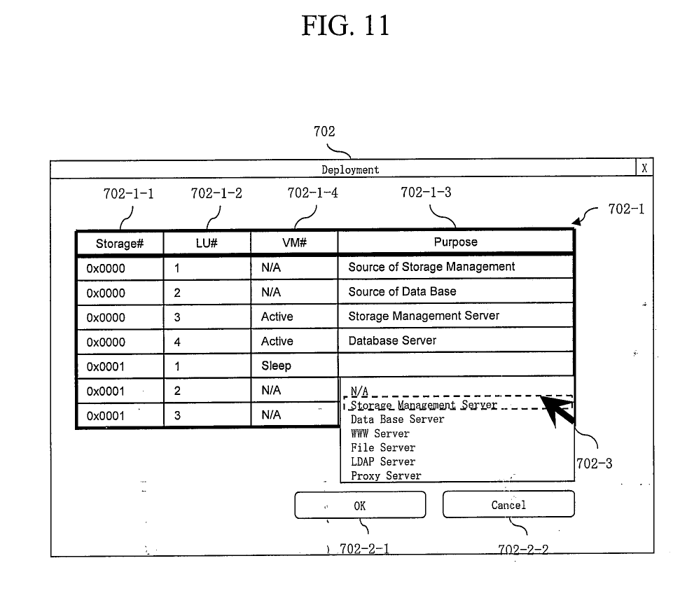

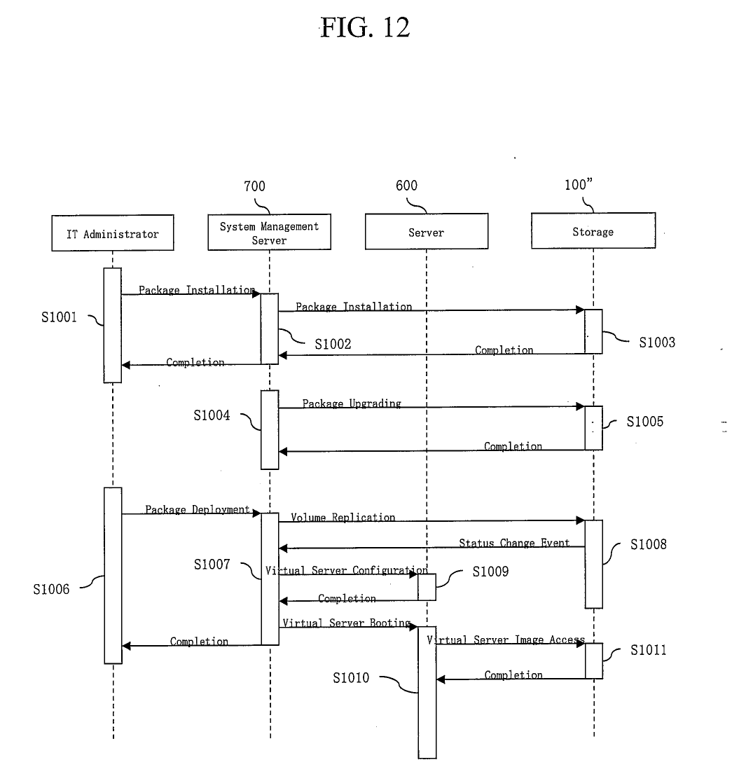

FIG. 9, FIG. 10, FIG. 11 and FIG. 12 pertain to features of a third aspect of the present invention. These drawings are used to show only the differences of the third aspect from the first aspect.

FIG. 9 shows a physical and logical system configuration according to a third aspect of the present invention.

The system of the third aspect of the present invention includes a storage subsystem 100″, the storage network 200, the host computer 300, general servers 600, and a system management server 700. The host computer 300 is similar to the one shown in FIG. 1 and is omitted from FIG. 9. The storage management server 400 of FIG. 1 is replaced by other servers in FIG. 9.

The general servers 600 can be used flexibly by using a virtual server program. The system management server 700 manages the storage subsystem 100″ and the virtual server in the general servers 600.

The storage subsystem 100″ includes volumes 101a, 101b, 101c, 101d, the logical volume management table 102 and the replication program 103. The storage management terminal 110 of the storage subsystem 100 of FIG. 1 is not present in FIG. 9 because management interface is now at the system management server 700.

The general servers 600 each include an operation system 601, a device management table 602, a virtual server program 603 and a virtual server management table 604.

The operation system 601 controls the application programs and devices of the general server. The device management table 602 stores device information that the general server uses. The virtual server program 603 splits and/or consolidates resource of the general server 600 and it can virtually run one or more servers in the general server 600. A bootable image of the virtual server is stored in the storage subsystem 100″. The virtual server management table 604 manages the relationship between the virtual server and the corresponding physical device in the general server 600.

The system management server 700 includes a deployment table 701, that manages volumes and installed software and a deployment interface that provides human interface for volume deployment.

FIG. 10 shows an exemplary deployment table, according to aspects of the invention.

The deployment table 702-1 includes columns corresponding to a storage number (Storage #) 701-1, a logical unit number (LU #) 701-2, a server number (Server #) 701-3, a virtual server number (VM #) 701-4, and a purpose of the volume (Purpose) 701-5.

The storage number 701-1 is a unique storage number to detect the location of the storage within the storage subsystem 100″. The logical volume number 701-2 is a unique volume number in the storage subsystem 100″ for managing the internal device structure. The general server number 701-3 is a unique physical server number to detect the pertinent general server. There may be one, two, three or more general servers such as general servers 600 in use in the system. The virtual server number 701-4 is a unique virtual server number within the general servers 600. The purpose 701-5 stores the purpose of the volume. For example, a source volume of deployment is stored as “Source of . . . ,” an entry of “Unused” means that the volume does not exist, it is not being replicated or it is not configured as a source volume . . .

FIG. 11 shows an exemplary deployment interface, according to aspects of the present invention.

The deployment interface 702 of the system management server 700 is shown in this drawing. A similar interface shown in FIG. 4 was part of the storage management terminal 110 of the storage subsystem 100 in FIG. 1. The deployment table 702 includes a volume configuration interface or table 702-1, an OK button 702-2-1, a cancel button 702-2-2 and a pointer 702-3.

The volume configuration table includes columns for a logical volume number (Storage #) 702-1-1, a logical unit number (LU #) 702-1-2, a virtual server number (VM #) 702-1-4 and a purpose of the volume 702-1-3. The entries of the volume configuration table 702-1 can be selected by the pointer 702-3 or can be input by keyboard. The system management server 700C can receive the logical volume management table 102 from the storage subsystem 100″. The system management server 700 generates the logical volume number 702-1-1, the logical unit number 702-1-2 and the purpose of the volume 702-1-3 and indicates the information from the deployment table 701 and the logical volume management table 102. Table 701 and table 102 may be used to fill the entries of table 702-1.

In the volume configuration table 702-1, the logical volume number 702-1-1 is a unique volume number in the storage subsystem 100″ for managing the internal storage device structure. The logical unit number 702-1-2 indicates the logical unit number 102-2. It is a volume number to be provided to the servers. An entry of “Unavailable” in this column means that the logical volume is not a defined LU #, The purpose 702-1-3 stores purpose of the volume. The source volumes are stored as “source of . . . ” in this column.

When the OK button 702-2-1 is pushed, the system management server 700 stores the status of the deployment table 701, tells the storage subsystem 100″ to change the logical volume management table 102 and orders the storage subsystem 100″ to activate the replication program 103 to replicate the sources indicated in the deployment table 702-1. Unless at least one entry of the purpose of volume 702-1-3 column, except those already being marked as source volumes, is changed, the system management server 700 does not order the storage subsystem 100 to activate the replication program 103. When the cancel button 702-2-2 is pushed, the system management server 700 destroys the changes made to the volume configuration 702-1. The pointer 702-3 works with mouse operation.

FIG. 12 shows an exemplary provisioning operation sequence of a virtual server, according to the third aspect of the present invention.

The provisioning operation sequence of the virtual server includes operations S1001 through S1011.

At S1001, the IT administrator uses the system management server 700 to install and set up an operation system and storage management software on volumes 101a and 101b. As a result of this operation, S1002 is executed.

At S1002, the system management server 700 installs operation systems and applications on the volumes 101a and 101b from a CD-ROM and/or a web page. After the installation operation completes, the system management server 700 configures the deployment table 701 indicating each volume receiving the installations as a source volume. After the configuration operation completes, the system management server 700 further shows a popup dialog that indicates the end of the program.

At S1003, the storage subsystem 100″ stores the operating system and applications, installed by execution of S1002, on the volumes 101a and 101b.

At S1004, when the system management server 700 finds an update of the installed operating system and/or applications by automatically downloading an update package, the system management server 700 sends the update of the operating system and/or applications to the volumes 101a and 101b. It further allows downloading of the updates from the internet. As a result of this operation, S1005 is executed.

At S1005, the storage subsystem 100 stores the update of the operation system and/or applications, received from the system management server 700, on the volumes 101a and 101b.

At S1006, the IT administrator selects a volume, deploys the virtual server and sets the purpose of the volume on the system management server 700. The IT administrator also waits for the completion return. As a result of this operation, S1007 is executed.

At S1007, the system management server 700 finds the source volume by analyzing the set purpose and replicates the source volume to the designated destination volume. After that, it waits to change the volume status to “Split” indicating an accessible volume. As a result of this operation, S1008 is executed. The system management server 700 makes a new configuration for the virtual server. The new configuration includes the foresaid replicated volume information. The system management server 700 deploys the virtual server on the general server 600 which would be the 1^{st} virtual server. When the system management server 700 deploys a 2^{nd} virtual server for storage management, it allows selecting the same general server 600 which executed the 1^{st} virtual server for storage management. After these operations are complete, the system management server 700 pops up a complete message.

At S1008, the storage subsystem 100″ changes the status of target volume to “Copy,” which indicates that the volume is inaccessible, and starts the replication operation. After the replication operation Completes, the storage subsystem 100″ changes the status to “Split.” The volume call become accessible soon after initialization. After the status changes to “Split,” the storage subsystem 100″ returns the status change event message.

At S1009, the general server 600 recognizes the designated volume and configures and initializes the virtual server. Then, the general server 600 returns a completion message.

At S1010, the general server 600 executes a virtual server with operating system applications in the deployed volumes and accesses the storage subsystem 100″. As a result of this access, S1011 is executed.

At S1011, the storage subsystem 100″ stores the operating system applications from the virtual servers of the general server 600 and returns a completion message to the general server 600.

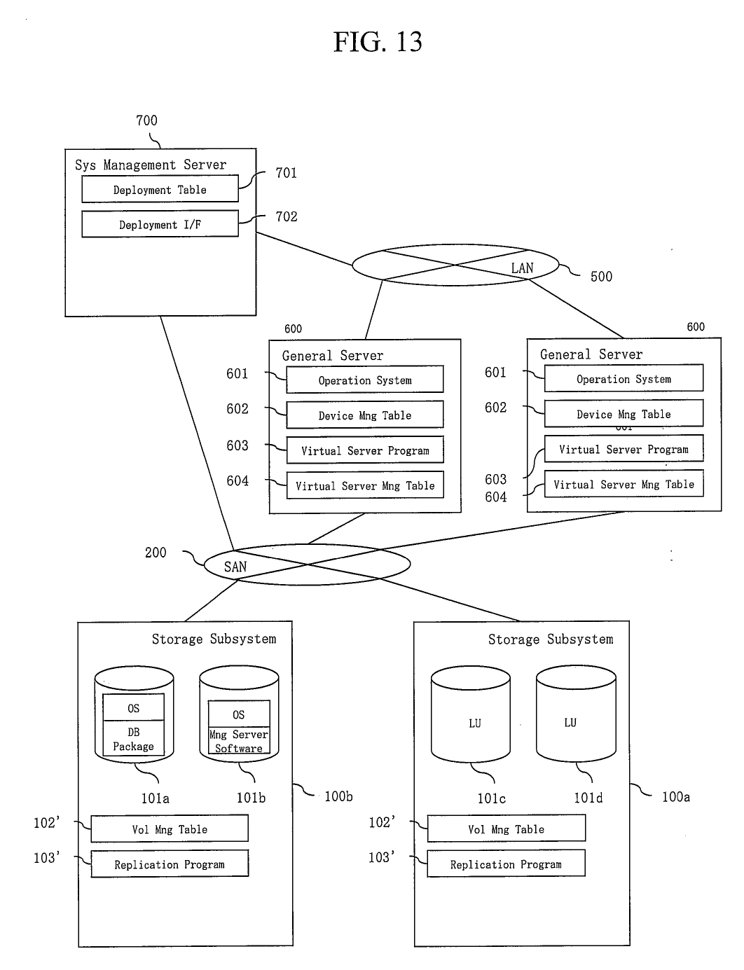

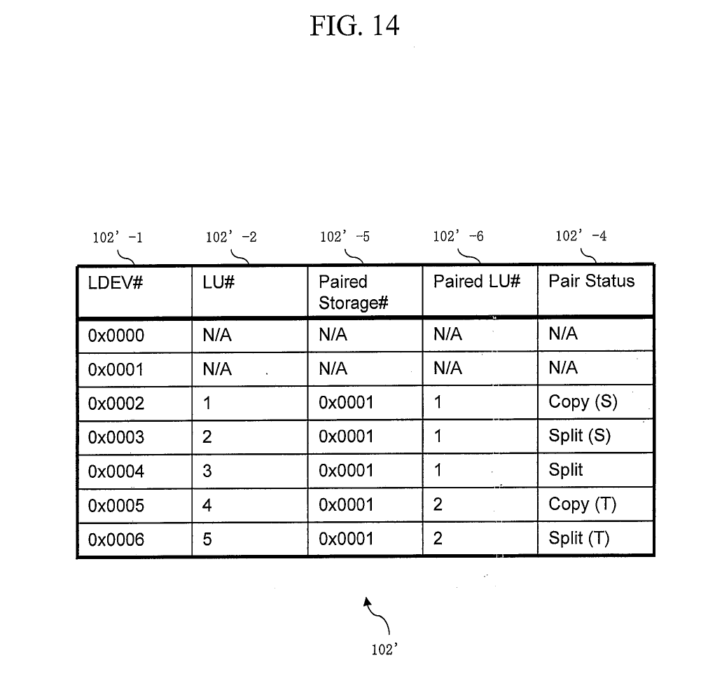

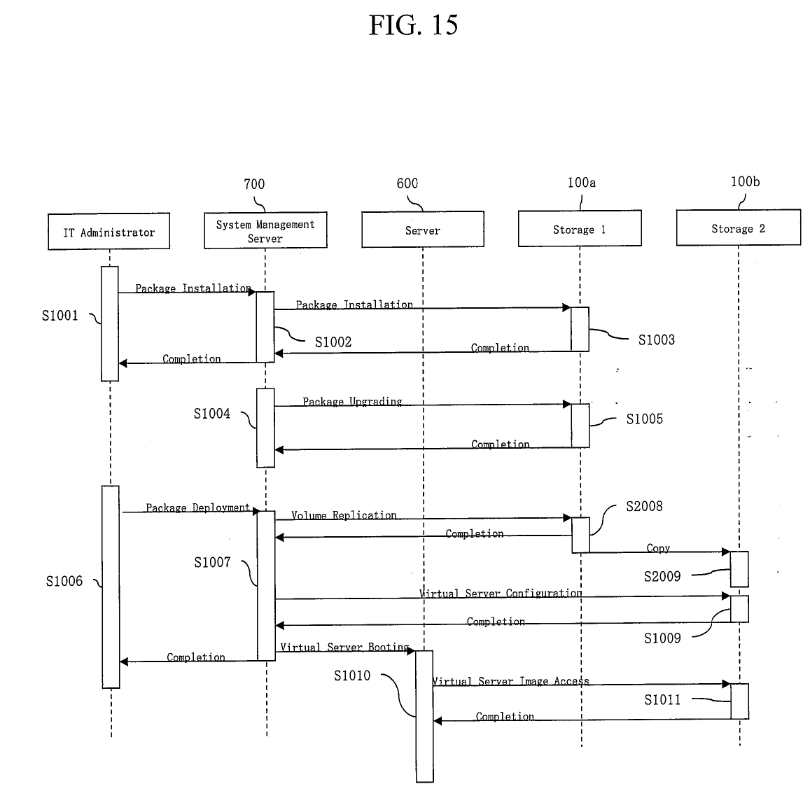

FIG. 13, FIG. 14 and FIG. 15 pertain to features of a fourth aspect of the present invention. These drawings are used to show only the differences of the fourth aspect from the third aspect.

FIG. 13 shows a physical and logical system configuration according to a fourth aspect of the present invention.

The physical storage system according to the fourth aspect of the present invention includes two storage subsystems 100a, 100b, the storage network 200, the host computer 300 that is not shown in FIG. 13, the general servers 600 and the system management server 700. The storage subsystems 100a and 100b of the fifth aspect are different from the storage subsystem 100″ of the fourth aspect of the invention that was shown in FIG. 9.

The volumes 101a, 100b, 101c and 101d that are divided between the storage subsystems 100a and 100b provide capacity for the servers that are coupled to the storage subsystems. The subsystem 100b includes the volumes 101a and 101b. The subsystem 100a includes the volumes 101c and 101d. Each of the storage subsystems 100a and 100b also includes a logical volume management table 102′ that manages the volumes 101a, 101b or the volumes 101c and 101d that are on the corresponding subsystem and a replication program 103′. The logical volume management table 102′ includes mapping information between logical units and logical devices number. The logical device number is an internal reference in the storage subsystem 100a or 100b. The replication program 103′ makes the volumes replicate between the storage subsystems 100a and 100b.

FIG. 14 shows an exemplary logical volume management table according to aspects of the present invention.

The logical volume management table 102′, shown in FIG. 14, includes columns corresponding to a logical volume number (LDEV #) 102′-1, a logical unit number (LU #) 102′-2, a paired storage number (Paired Storage #) 102′-5, a Paired LU number (Paired LU #) 102′-6 and a pair status (Pair Status) 102′-4.

The logical volume number 102′-1 is a unique volume number in the storage subsystem 100a or 100b for managing the internal device structure. The logical unit number 102′-2 is a volume number that is provided to the servers. An entry of “N/A” in this column means that the logical volume is not provided to the servers. The pair status 102′-4 stores the pair status and relationship between the volumes. An entry of “Copy” in this column means that the volume is copying, i.e., it is being copied to or being copied from, and cannot be accessed. An entry of “Split” means that the volume has completed copying and can be accessed. An entry of “(S)” next to “Copy” or “Split” means that the volume is a source of replication; an entry of “(T)” means that the volume is a target of replication; and finally an entry of “N/A” means that the volume is not being replicated. The paired storage number 102′-5 stores source or target storage number of volume replication. An entry of “N/A” means that the volume is not being replicated. A reference to the pair status 102′-4 determines whether the entry in 102′-5 is a source or a target. If 102′-4 includes an “(S),” then the storage volume listed in the paired storage column 102′-5 would be a target of the logical volume in 102′-2. The paired logical volume number 102′-6 stores source or target logical volume number of volume replication. An entry of “N/A” means that there is no target for the volume in 102′-2 and that this volume is not being replicated.

FIG. 15 shows an exemplary provisioning operation sequence of a virtual server in a system according to the fourth aspect of the present invention.

The provisioning operation sequence of the fourth aspect of the invention includes operations S1001 through S1007 and S1009 through S1011 that are similar to the operations of the third aspect. However, the fourth aspect excludes S1008 and instead includes operations S2008 and S2009. S1008 in the third aspect of the invention is split into two operations S2008 and S2009 in the fourth aspect.

At S2008, the storage subsystem 100a changes the status of it own volume to “Copy (S)” and changes the target storage subsystem 100b volume to “Copy (T)” and starts the replication operation. After the replication operation completes, storage subsystems 100a and 100b both change their status to “Split.” The storage subsystem 100a sends volume data to the storage subsystem 100b. After the status changes to “Split,” the storage subsystem 100a returns the status change event message.

At S2009, the storage subsystem 100b receives volume data and stores this data.

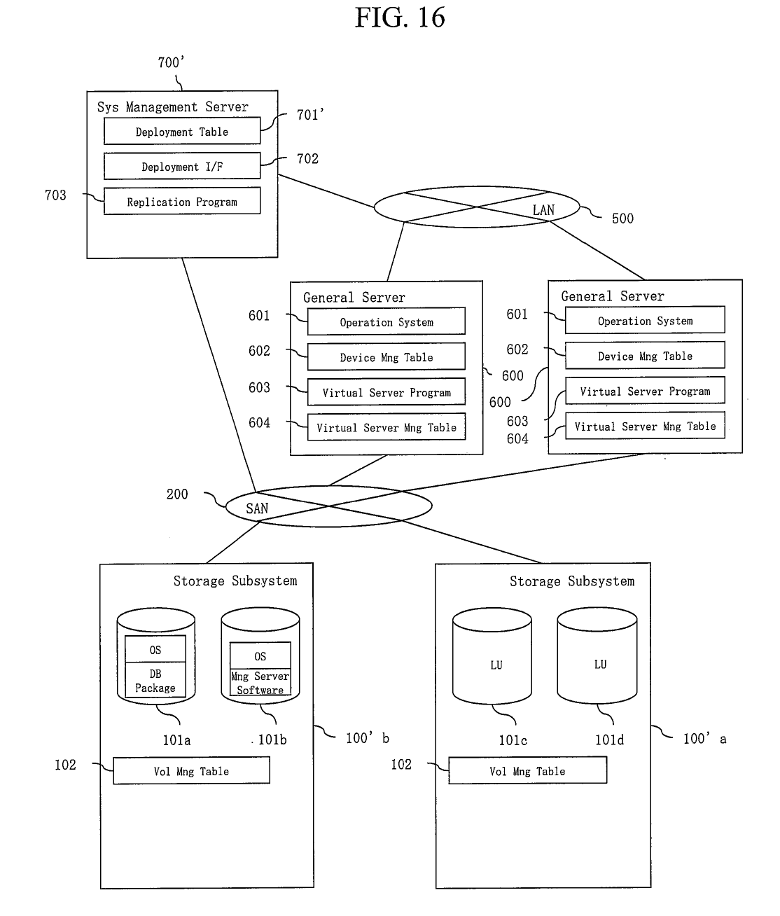

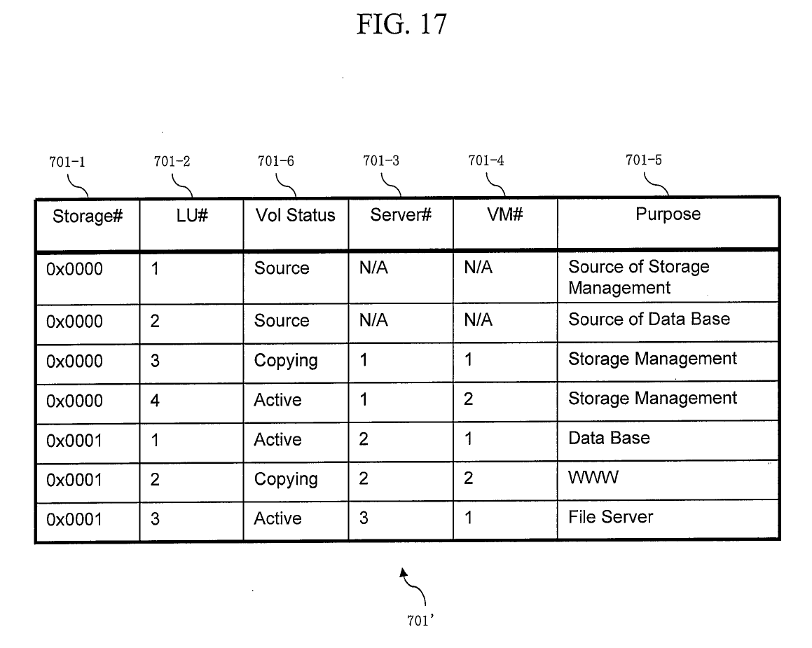

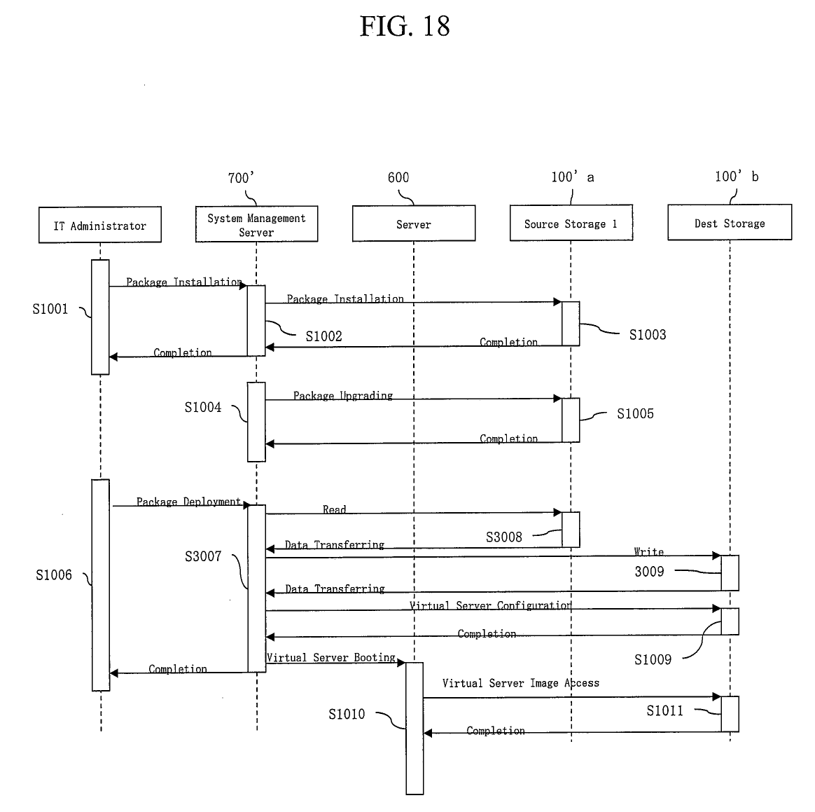

FIG. 16, FIG. 17 and FIG. 18 pertain to features of a fifth aspect of the present invention. These drawings are used to show only the differences of the fifth aspect from the fourth aspect.

FIG. 16 shows a physical and logical system configuration according to a fifth aspect of the present invention.

The physical storage system according to the fifth aspect of the present invention includes two storage subsystems 100′a, 100′b, the storage network 200, the host computer 300 that is not shown in FIG. 16, the general servers 600 and a system management server 700′. The storage subsystems 100′a and 100′b of the fifth aspect are different from the storage subsystems 100a and 100b of the fourth aspect of the invention that was shown in FIG. 13. Further, the system management server 700′ of the fifth embodiment is different from the system management server 700 of the fourth embodiment that was shown in FIG. 13.

The subsystems 100′a and 100′b each include the logical volume management table 102 but not the replication program 103′ that was shown in FIG. 13.

The system management server 700′ includes the deployment Interface 702 and the replication program 703 that makes volumes replicate between storage subsystem 100′a and 100′b. However, the system management server 700′ additionally includes a deployment table 701′ that manages the volumes and the installed software.

FIG. 17 shows an exemplary deployment table according to aspects of the present invention.

The deployment table 701′, shown in FIG. 17, includes columns corresponding to storage number (Storage #) 701-1, logical volume number (LU #) 701-2, general server number (Server #) 701-3, virtual server number (VM #) 701-4, purpose of volume (Purpose) 701-5, and volume status (Vol Status) 701-6.

The volume status column 701-6 stores volume status. An entry of “Source” means the volume is a source volume. An entry of “Copying” means that the system management server 700′ is copying data from the source volume to this volume. An entry of “Active” means that the volume has already been copied from the source volume.

FIG. 18 shows an exemplary provisioning operation sequence of a virtual server in a system according to the fifth aspect of the present invention.

The provisioning operation sequence of the fifth aspect of the invention includes operations S1001 through S1006 and S1009 through S1011 that are similar to the operations of the fourth aspect. However, in the fifth aspect excludes S1007, S2008 and S2009 and instead includes operations S3007, S3008 and S3009. S1007 in the fourth aspect of the invention is replaced by S3007, S2008 in the fourth aspect is replaced by S3008 and S2009 in the fourth aspect is replaced with S3009 in the fifth aspect.

At S3007 the system management server 700′ finds the source volume by analyzing the set purpose. The system management server 700′ then changes the target volume status to “Copying,” and reads the source volume at the storage subsystem 100′a. As a result of this operation, S2008 is executed. The system management server 700′ writes to the target volume at the storage subsystem 100′b. As a result of this operation, S2009 is executed. The system management server 700′ creates a new configuration for the virtual servers. The new configuration includes the foresaid replicated volume information. The system management server 700′ changes the target volume status to “Active.” The system management server 700′ deploys the virtual server on the general server 600. When the system management server 700 deploys the second virtual server for storage management, it allows selecting the same general server 600 which executed the first virtual server for storage management. After these operations are complete, the system management server 700′ pops up a complete message.

At S3008, the storage subsystem 100′a receives a read I/O and transfers the volume data to the system management server 700′.

At S3009, the storage subsystem 100′a receives a write I/O and stores the volume data.

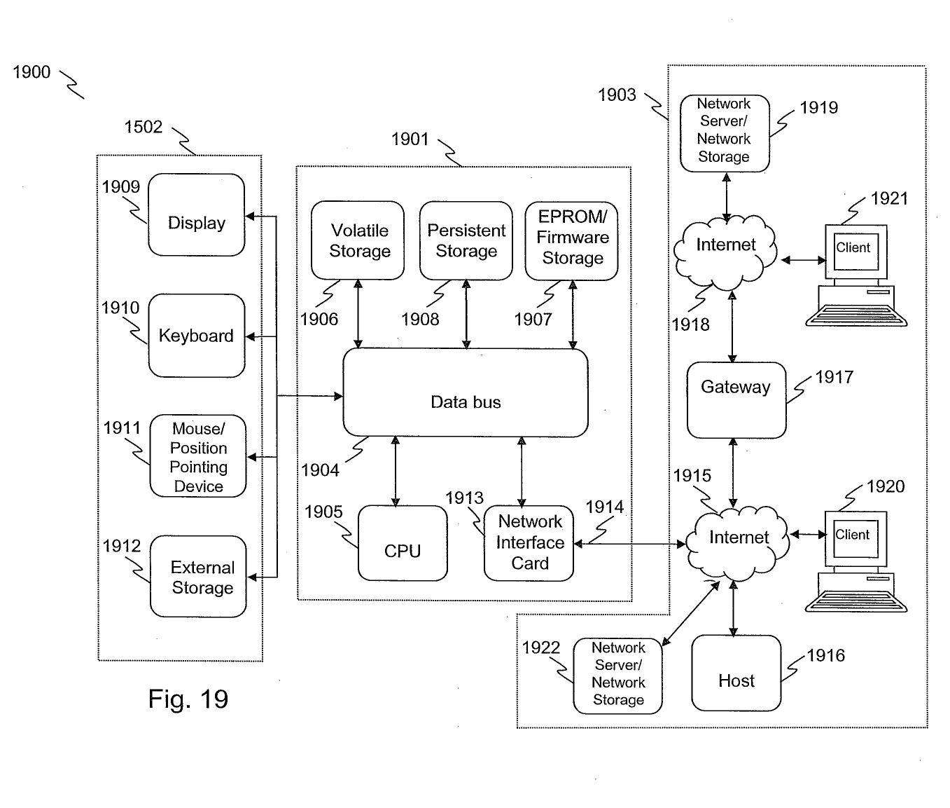

FIG. 19 is a block diagram that illustrates an embodiment of a computer/server system 1900 upon which an embodiment of the inventive methodology may be implemented. The system 1900 includes a computer/server platform 1901, peripheral devices 1902 and network resources 1903.

The computer platform 1901 may include a data bus 1904 or other communication mechanism for communicating information across and among various parts of the computer platform 1901, and a processor 1905 coupled with bus 1901 for processing information and performing other computational and control, tasks. Computer platform 1901 also includes a volatile storage 1906, such as a random access memory (RAM) or other dynamic storage device, coupled to bus 1904 for storing various information as well as instructions to be executed by processor 1905. The volatile storage 1906 also may be used for storing temporary variables or other intermediate information during execution of instructions by processor 1905. Computer platform 1901 may further include a read only memory (ROM or EPROM) 1907 or other static storage device coupled to bus 1904 for storing static information and instructions for processor 1905, such as basic input-output system (BIOS), as well as various system configuration parameters. A persistent storage device 1908, such as a magnetic disk, optical disk, or solid-state flash memory device is provided and coupled to bus 1901 for storing information and instructions.

Computer platform 1901 may be coupled via bus 1904 to a display 1909, such as a cathode ray tube (CRT), plasma display, or a liquid crystal display (LCD), for displaying information to a system administrator or user of the computer platform 1901. An input device 1910, including alphanumeric and other keys, is coupled to bus 1901 for communicating information and command selections to processor 1905. Another type of user input device is cursor control device 1911, such as a mouse, a trackball, or cursor direction keys for communicating direction information and command selections to processor 1904 and for controlling cursor movement on display 1909. This input device typically has two degrees of freedom in two axes, a first axis (e.g., x) and a second axis (e.g., y), that allows the device to specify positions in a plane.

An external storage device 1912 may be coupled to the computer platform 1901 via bus 1904 to provide an extra or removable storage capacity for the computer platform 1901. In an embodiment of the computer system 1900, the external removable storage device 1912 may be used to facilitate exchange of data with other computer systems.

The invention is related to the use of computer system 1900 for implementing the techniques described herein. In an embodiment, the inventive system may reside on a machine such as computer platform 1901. According to one embodiment of the invention, the techniques described herein are performed by computer system 1900 in response to processor 1905 executing one or more sequences of one or more instructions contained in the volatile memory 1906. Such instructions may be read into volatile memory 1906 from another computer-readable medium, such as persistent storage device 1908. Execution of the sequences of instructions contained in the volatile memory 1906 causes processor 1905 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1905 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1908. Volatile media includes dynamic memory, such as volatile storage 1906. Transmission media includes coaxial cables, copper wire and fiber optics, including the wires that comprise data bus 1904. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 1905 for execution. For example, the instructions may initially be carried on a magnetic disk from a remote computer. Alternatively, a remote computer can load the instructions into its dynamic memory and send the instructions over a telephone line using a modem. A modem local to computer system 1900 can receive the data on the telephone line and use an infra-red transmitter to convert the data to an infra-red signal. An infra-red detector can receive the data carried in the infra-red signal and appropriate circuitry can place the data on the data bus 1904. The bus 1904 carries the data to the volatile storage 1906, from which processor 1905 retrieves and executes the instructions. The instructions received by the volatile memory 1906 may optionally be stored on persistent storage device 1908 either before or after execution by processor 1905. The instructions may also be downloaded into the computer platform 1901 via Internet using a variety of network data communication protocols well known in the art.

The computer platform 1901 also includes a communication interface, such as network interface card 1913 coupled to the data bus 1904. Communication interface 1913 provides a two-way data communication coupling to a network link 1914 that is coupled to a local network 1915. For example, communication interface 1913 may be an integrated services digital network (ISDN) card or a modem to provide a data communication connection to a corresponding type of telephone line. As another example, communication interface 1913 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1913 sends and receives electrical, electromagnetic or optical signals that carry digital data streams representing various types of information.

Network link 1913 typically provides data communication through one or more networks to other network resources. For example, network link 1914 may provide a connection through local network 1915 to a host computer 1916, or a network storage/server 1917. Additionally or alternatively, the network link 1913 may connect through gateway/firewall 1917 to the wide-area or global network 1918, such as an Internet. Thus, the computer platform 1901 can access network resources located anywhere on the Internet 1918, such as a remote network storage/server 1919. On the other hand, the computer platform 1901 may also be accessed by clients located anywhere on the local area network 1915 and/or the Internet 1918. The network clients 1920 and 1921 may themselves be implemented based on the computer platform similar to the platform 1901.

Local network 1915 and the Internet 1918 both use electrical, electromagnetic or optical signals that carry digital data streams. The signals through the various networks and the signals on network link 1914 and through communication interface 1913, which carry the digital data to and from computer platform 1901, are exemplary forms of carrier waves transporting the information.

Computer platform 1901 can send messages and receive data, including program code, through the variety of network(s) including Internet 1918 and LAN 1915, network link 1914 and communication interface 1913. In the Internet example, when the system 1901 acts as a network server, it might transmit a requested code or data for an application program running on client(s) 1920 and/or 1921 through Internet 1918, gateway/firewall 1917, local area network 1915 and communication interface 1913. Similarly, it may receive code from other network resources.

The received code may be executed by processor 1905 as it is received, and/or stored in persistent or volatile storage devices 1908 and 1906, respectively, or other non-volatile storage for later execution. In this manner, computer system 1901 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, per, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized systems for establishing new information technology systems. It is intended that the specification and examples be considered as exemplary only, with a true scope and spirit of the invention being indicated by the following claims.

What is claimed is:

1. A computer-implemented method performed in a system comprising a storage system having a plurality of logical volumes, a host computer and a storage management server, the method comprising:
a. Installing at least one software package on a source logical volume of the plurality of logical volumes;
b. Recording a purpose of the source logical volume having the software package installed thereon;
c. Receiving a volume selection from a user identifying the target volume of the plurality of logical volumes;
d. Receiving a target volume purpose selection from the user;
e. Using the target volume purpose selection to locate a source volume corresponding to the target volume purpose selection;
f. Using the source volume to replicate the at least one software package to the target volume; and
g. Configuring the host computer or the storage management server to operate with the target volume.

2. The method of claim 1, further comprising applying an update to the software package stored in the source logical volume.

3. The method of claim 1, wherein the software package comprises an operating system.

4. The method of claim 1, wherein the software package comprises a storage management software.

5. The method of claim 1, wherein the software package comprises an application program.

6. A computer-implemented method performed in a system comprising a storage system comprising a plurality of logical volumes, a host computer and a storage management server, the method comprising:
a. Installing at least one software package on a source logical volume of the plurality of logical volumes;
b. Recording a purpose of the source logical volume having the software package installed thereon;
c. Receiving a volume selection from a user identifying the target volume of the plurality of logical volumes;
d. Receiving a target volume purpose selection from the user;
e. Using the target volume purpose selection to locate a source volume corresponding to the target volume purpose selection;
f. Using the source volume to perform a snapshot copy of the at least one software package to the target volume; and
g. Configuring the host computer or the storage management server to operate with the target volume, wherein the target volume is a virtual volume having no physical storage capacity.

7. The method of claim 6, further comprising storing difference data in a difference data volume, the difference data being indicative of a difference between data in the source volume and data in the target volume.

8. The method of claim 6, further comprising applying an update to the software package stored in the source logical volume.

9. The method of claim 6, wherein the software package comprises an operating system.

10. The method of claim 6, wherein the software package comprises a storage management software.

11. The method of claim 6, wherein the software package comprises an application program.

12. A computer-implemented method performed in a system comprising a storage system having a plurality of logical volumes and a physical server platform, the method comprising:
a. Installing at least one software package on a source logical volume of the plurality of logical volumes;
b. Recording a purpose of the source logical volume having the software package installed thereon;
c. Establishing at least one new virtual server on a physical server platform;
d. Receiving a volume selection from a user identifying the target volume of the plurality of logical volumes;
e. Receiving a target volume purpose selection from the user;
f. Using the target volume purpose selection to locate a source volume corresponding to the target volume purpose selection;
g. Using the source volume to replicate the at least one software package to the target volume; and
h. Configuring the at least one new virtual server to operate with the target volume.

13. The method of claim 12, further comprising applying an update to the software package stored in the source logical volume.

14. The method of claim 12, wherein the software package comprises an operating system.

15. The method of claim 12, wherein the software package comprises a storage management software.

16. The method of claim 12, wherein the software package comprises an application program.

17. A computer-implemented method performed in a system comprising at least a first and a second storage subsystems each having a plurality of logical volumes and a physical server platform, the method comprising:
a. Installing at least one software package on a source logical volume of the plurality of logical volumes of the first storage subsystem;
b. Recording a purpose of the source logical volume having the software package installed thereon;
c. Establishing at least one new virtual server on the physical server platform;
d. Receiving a volume selection from a user identifying the target volume of the plurality of logical volumes of the second storage subsystem;
e. Receiving a target volume purpose selection from the user;
f. Using the target volume purpose selection to locate a source volume corresponding to the target volume purpose selection;
g. Using the source volume to replicate the at least one software package to the target volume; and
h. Configuring the at least one new virtual server to operate with the target volume.

18. The method of claim 17, further comprising applying an update to the software package stored in the source logical volume.

19. The method of claim 17, wherein the software package comprises an operating system.

20. The method of claim 17, wherein the software package comprises a storage management software.

21. The method of claim 17, wherein the software package comprises an application program.

22. A computerized system comprising:
a. A host computer;
b. A storage management server;
c. A storage subsystem comprising a plurality of logical volumes and a storage management terminal, the plurality of logical volumes comprising a source logical volume storing at least one software package; the storage management terminal operable to record a purpose of the source logical volume having the software package installed thereon; receive a volume selection from a user identifying the target volume of the plurality of logical volumes; receive a target volume purpose selection from the user; use the target volume purpose selection to locate a source volume corresponding to the target volume purpose selection; and use the source volume to cause the at least one software package to be replicated to the target volume;
d. A host computer, wherein the host computer or the storage management server is operable to be configured to operate with the target volume; and
e. A storage network coupling the storage subsystem, the storage management server and the host computer.

23. The computerized system of claim 22, wherein the host computer is operable to recognize the target volume, wherein the at least one software package comprises an application program and wherein the host computer is operable to execute the application program.

24. The computerized system of claim 22, wherein the storage management server is operable to recognize the target volume as a boot volume, wherein the at least one software package comprises an operating system and wherein the storage management server is operable to boot using the target volume.

25. The computerized system of claim 22, wherein the storage subsystem is operable to apply an update to the software package stored in the source logical volume.

26. The computerized system of claim 22, further comprising a server network interconnecting the host computer and the storage management server.

27. A computerized system comprising:
a. A host computer;
b. A storage management server;
c. A storage subsystem comprising a plurality of logical volumes and a storage management terminal, the plurality of logical volumes comprising a source logical volume storing at least one software package; the storage management terminal operable to record a purpose of the source logical volume having the software package installed thereon; receive a volume selection from a user identifying the target volume of the plurality of logical volumes; receive a target volume purpose selection from the user; use the target volume purpose selection to locate a source volume corresponding to the target volume purpose selection; and use the source volume to cause the at least one software package to be snapshot copied to the target volume;
d. A host computer, wherein the host computer or the storage management server is operable to be configured to operate with the target volume; and
e. A storage network coupling the storage subsystem, the storage management server and the host computer, wherein the target volume is a virtual volume having no physical storage capacity.

28. The computerized system of claim 27, further comprising a difference data volume storing difference data, the difference data being indicative of a difference between data in the source volume and data in the target volume.

29. The computerized system of claim 27, wherein the host computer is operable to recognize the target volume, wherein the at least one software package comprises an application program and wherein the host computer is operable to execute the application program.

30. The computerized system of claim 27, wherein the storage management server is operable to recognize the target volume as a boot volume, wherein the at least one software package comprises an operating system and wherein the storage management server is operable to boot using the target volume.

31. The computerized system of claim 27, wherein the storage subsystem is operable to apply an update to the software package stored in the source logical volume.

32. The computerized system of claim 27, further comprising a server network interconnecting the host computer and the storage management server.

33. A computerized system comprising:
a. At least one physical server platform operable to host at least one virtual server;
b. At least one storage subsystem comprising a plurality of logical volumes, the plurality of logical volumes comprising a source logical volume storing at least one software package;
c. A system management server operable to record a purpose of the source logical volume having the software package installed thereon; receive a volume selection from a user identifying the target volume of the plurality of logical volumes; receive a target volume purpose selection from the user; deploy a new virtual server using the physical server platform; use the target volume purpose selection to locate a source volume corresponding to the target volume purpose selection; and use the source volume to cause the at least one software package to be replicated to the target volume; and
d. A storage network coupling the storage subsystem, the system management server and the physical server platform, wherein the new virtual server is configurable to operate with the target volume.

34. The computerized system of claim 33, wherein the physical server platform is operable to recognize the target volume, wherein the at least one software package comprises an operating system or an application program and wherein the physical server platform is operable to initiate the new virtual server to execute with the operating system or the application program.

35. The computerized system of claim 33, wherein the source logical volume and the target logical volume are disposed in different storage subsystems.

36. The computerized system of claim 33, wherein the at least one storage subsystem comprises a replication module operable to replicate the at least one software package from the source volume to the target volume.

37. The computerized system of claim 33, wherein the system management server comprises a replication module operable to replicate the at least one software package from the source volume to the target volume.
